(19) United States
(12) Patent Application Publication
(10) Pub. No.: US 2007/0244975 A1
(43) Pub. Date: Oct. 18, 2007

(54) System and methods for processing operating experience data

(75) Inventors: James J. Dillon, Augusta, GA (US); Ron L. Wilson, Hephziba, GA (US); Robert C. Cain, Columbiana, AL (US)

Correspondence Address: TROUTMAN SANDERS LLP, 600 PEACHTREE STREET , NE, ATLANTA, GA, 30308, US

(73) Assignee: The Southern Company, Atlanta, GA (US)

(21) Appl. No.: 11/701,740

(22) Filed: Feb. 2, 2007

Related U.S. Application Data
(60) Provisional application No. 60/792,742, filed on Apr. 18, 2006.

(51) Int. Cl. G06F 15/16

(52) U.S. Cl. 709/206

(57) ABSTRACT

A system and method for processing operating experience data. The operating experience data is received and parsed into individual message and attachment files. Using user provided search criteria, the individual messages and attachment files are filtered in order to discover messages and attachment files containing or relating to the search criteria provided by the user. The filter results are then provided to the user for review.

### CROSS REFERENCE TO RELATED APPLICATION

This application claims priority of U.S. Provisional Patent Application No. 60/792,742 filed 18 Apr. 2006, the entire contents of which is hereby incorporated by reference.

### TECHNICAL FIELD

The present invention relates, generally, to a system for processing operating experience data, and, more particularly, to a system for processing operating experience data utilizing user provided search criteria.

### BACKGROUND OF THE INVENTION

Environmental, safety, and health concerns are top priorities in the highly-regulated nuclear power industry. To encourage shared communications between nuclear power companies throughout the world, the nuclear electric utility industry created the Institute of Nuclear Power Operations (INPO) in 1979. INPO is a self-regulated organization authorized by the U.S. Congress as a result of the 1979 Three Mile Island incident. Generally, INPO's purpose is to promote the highest levels of safety and reliability in the operation of nuclear electric generating plants. All organizations within the United States that operate commercial nuclear power plants are required to be members of INPO. Further, nuclear operating organizations within other foreign countries, as well as nuclear steam supply system, architect/engineering and construction firms, can be participants of INPO.

Even the Department of Energy (DOE) has made contractual arrangements with INPO that provide employees of the DOE nuclear facility federal and management and operating company access to certain INPO products and services. More particularly, the activities specified in the contract provide the DOE with operational experiences, methods, information, and data developed for the commercial nuclear industry through the programs and activities undertaken by INPO.

One of the major contributions that INPO provides to the commercial nuclear industry is a collection of shared operating experience and data provided by its members. Generally, there are two different levels of industry operating experience (OE) that INPO offers. The first type includes Significant Event Evaluation Information Notice (SEE-IN) documents, which are “high level” documents produced by INPO after conducting a screening process on specific industry events. The second type includes an “information only” collection of new industry operating experiences that have occurred over the last twenty-four hours. This new information is gathered from the INPO members and compiled into a data file known as the “daily download.” Unlike the SEE-IN documents, the information provided in the “daily download” does not require a particular nuclear power company to generate a formal written response. Accordingly, the operating experience provided in the “daily download” is often referred to as low-level operating experience (LLOE).

The “daily download” file received from the INPO server is generally a large and cumbersome data file including multiple messages directed towards different aspects of the commercial nuclear industry. The messages can also include one or more attachments, such as, but not limited to, text documents, drawings, photographs, audio, and/or video. The attachments, however, are generally in an encoded text format that requires conversion back to binary format, before the attachments are useable. As most commercial nuclear power companies include multiple departments and individuals responsible for different processes and sections of the nuclear power plant, only portions of the “daily download” file are typically relevant to any one department or individual within the company. The ultimate size of the “daily download” file, however, makes the process of viewing relevant messages by certain departments and/or individuals an almost impossible task, because the “daily download” generally contains so many potentially irrelevant topics to sift through by the department or individual.

In effort to provide more relevant information to the particular departments and individuals at a commercial nuclear power company, software programs have been developed to filter out content (e.g., relevant messages) from the “daily download” data file. Generally, a department and/or individual selects or creates predetermined keywords in which the department and/or individual desires to receive all messages (from within the “daily download” file) containing topics related to the keywords.

Although sufficient for their intended purposes, the software programs developed to filter out content from the “daily download” data contained several drawbacks. First, the methodology for updating, deleting, adding, or modifying keywords for a particular user often entailed a manual procedure that introduced an unacceptable delay in providing appropriate content to the department or individual. Further, if several departments or individuals wanted to change their respective keywords, the manual process had to be repeated, thereby causing delay.

Second, the information or relevant messages filtered from the “daily download” file by the software programs and provided to the users (e.g., departments and/or individuals) was not user friendly. Often the information received by the user had no separation between messages, did not specify which keyword was found in the message, and often provided very lengthy messages that were difficult to digest by the user. Further, attachments could not be processed and provided to the user. Because the information received by the user was difficult to read and process, many users would simply ignore or delete the results and, therefore, the commercial nuclear power company would not benefit from the shared operating experience provided through INPO.

Finally, the software programs utilized to filter the “daily download” file did not typically generate a summary of which messages were provided to each user. Consequently, when a user accidentally deleted or lost the results, the software program would have to be run again to generate the same results provided previously.

Accordingly, there is a need in the art for a system and methods for processing operating experience data based on user provided search criteria, such that the generated results are user-friendly.

There is also a need in the art for a system and methods for processing operating experience data that can also provide important attachments that correspond to an operating experience message.

Additionally, there is a need in the art for a system and methods for processing operating experience data that permits the addition, deletion, or modification of search criteria for a particular user in an automatic and convenient manner. It is to such a system and methods that the present invention is primarily directed.

### BRIEF SUMMARY OF THE INVENTION

Generally described, the present invention comprises a system and methods for processing operating experience data. The operating experience data is received and parsed into individual messages, which may include attachment files. Using user provided search criteria, the individual messages and attachment files are filtered in order to discover messages and attachment files containing or relating to the search criteria provided by the user. Each entry in the set of filter results generally includes a link to the corresponding message file, the message subject, and an abstract or summary of the message. The filter results can then be provided to the user for review. Further, a distribution summary may be generated including the subject of each message having information sent to a user and a list of uses to which the message information had been sent.

More specifically, the present invention comprises a memory storage device, a user interface, and a data processing unit. The user interface is adapted to allow a user or administrator to provide search criteria for a particular user. The memory storage device is adapted to store and provide operating experience (OE) data and all generated files and summaries. The data processing unit includes a data parsing unit, a data filtering unit, and a distribution unit for the processing of the OE data. The data parsing unit is capable of parsing the received OE data into individual message and attachment files, which can then be saved in a user accessible directory within the memory storage unit. The data filtering unit is capable of using the provided search criteria for a user to filter the individual message and attachment files in order to find matches (e.g., discover message and attachment files containing a keyword or related to a particular forum). The data filtering unit further creates a set of filter results for each user in which a positive match has been found. The distribution unit is capable of providing the set of filter results to each corresponding user. Further, the distribution unit generates a distribution summary that outlines which message and attachment files were matched and provided to each user.

Other features and advantages of the present invention will become apparent upon reading and understanding the present specification when taken in conjunction with the appended drawings.

### BRIEF DESCRIPTION OF THE FIGURES

FIG. 1 displays a block diagram representation of a system for processing operating experience data in accordance with exemplary embodiments of the present invention.

FIG. 2 displays a block diagram representation of a computing environment which may be utilized in accordance with exemplary embodiments of the present invention.

FIG. 3 displays a block diagram representation of an operating experience extractor server utilized to process received operating experience data in accordance with exemplary embodiments of the present invention.

FIGS. 4A-4B, collectively known as FIG. 4, display a logic flow diagram representing a method of parsing received operating experience data in accordance with exemplary embodiments of the present invention.

FIGS. 5A-5B, collectively known as FIG. 5, display a logic flow diagram representing a method of filtering operating experience files based on predetermined user search criteria in accordance with exemplary embodiments of the present invention.

FIG. 6 displays a logic flow diagram representing a method of distributing filtered results to users in accordance with exemplary embodiments of the present invention.

### DETAILED DESCRIPTION OF THE INVENTION

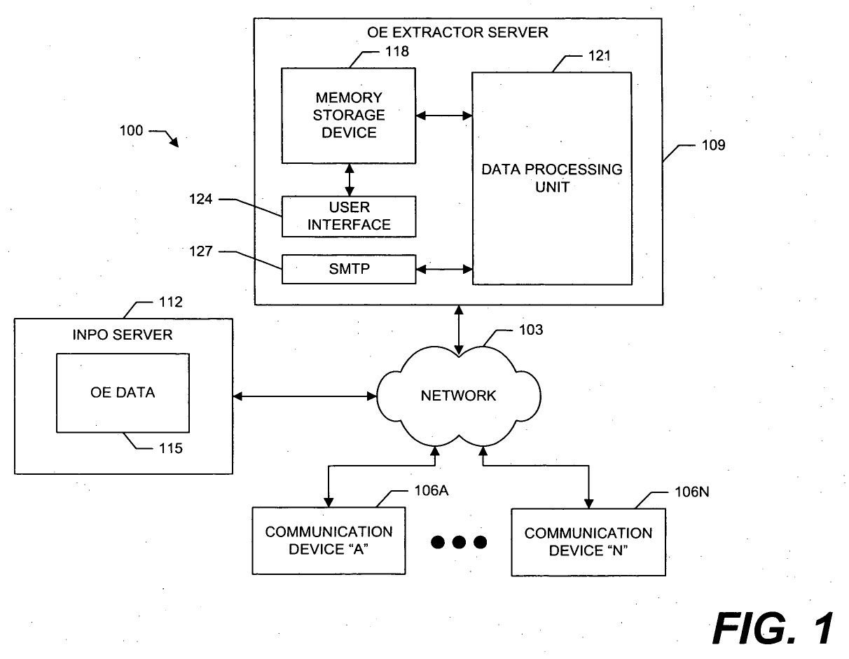

Referring now to the drawings, in which like numerals represent like components or steps throughout the several views, FIG. 1 displays a block diagram representation of a system 100 for processing operating experience data in accordance with exemplary embodiments of the present invention. Generally, the operating experience (“OE”) processing system 100 comprises an OE extractor server 109, an INPO server 112, and a number of communication devices 106A-106N connected together via a communication network 103 (i.e., also referred to herein as a “network 103”). One skilled in the art will recognize that the network 103 typically contains the infrastructure and facilities appropriate to connect a group of two or more communication devices 106A-106N (including, without limitation, a number of computer systems in communication with each other), along with the OE extractor server 109 and INPO server 112.

The network 103, OE extractor server 109, INPO server 112, and communication devices 106A-106N can be configured in multiple network topologies including, but not limited to, star, bus, or ring configurations. Also, the network 103, OE extractor server 109, INPO server 112, and communication devices 106A-106N can be broadly categorized as belonging to a particular architecture including, but not limited to, peer-to-peer or client/server architectures. The network 103 can additionally be classified by the geographical location of the communication devices 106A-106N and the types thereof. For example, if the network 103 connects a number of computer systems or servers located in relatively close proximity to each other, such as within a building, the network 103 is referred to as a local-area network (LAN). If the computer systems are located farther apart, the network 103 is generally referred to as a wide-area network (WAN), such as the Internet. If the computer systems are located within a limited geographical area, such as a university campus or military establishment, the network 103 is referred to as a campus-area network (CAN). Similarly, if the computer systems are connected together within a city or town, the network 103 is referred to as a metropolitan-area network (MAN). Finally, if the computer systems are connected together within a user's home, the network 103 is referred to as a home-area network (HAN).

Further the present invention can include a network 103 that does not rely on the client/server architecture. Accordingly, OE extractor server 109 can include a client machine rather than a server, wherein communication between the communication devices 106A-106N and the OE extractor server 109 occurs over shared network drives.

The number of communication devices 106A-106N within the OE processing system 100 can vary depending on the requirements of the OE processing system 100. In one embodiment of the present invention, the number of communication devices 106A-106N corresponds to the number of users (e.g., departments or individuals) registered to receive results (based on predetermined search criteria) from the OE processing system 100 via the OE extractor server 109. For example and not limitation, the results generated by the OE processing system 100 can be provided to each registered user through the use of e-mail. Accordingly, each communication device 106A-106N can include a basic e-mail application (not shown) that allows the user to adequately access and receive the results generated by the OE processing system 100, as described more fully below.

The OE extractor server 109, INPO server 112, and each communication device 106A-106N connect to the network 103, through use of a network interface and other appropriate hardware and software components, for bi-directional communication of signals and data therewith and, therefore, connect communicatively to each other.

The INPO Server 112 can include a repository of OE data 115, which can be provided to the OE Extractor Server 109 via the network 103 on a predetermined basis, such as every twenty-four hours. The OE data 115 can include industry operating experience of commercial nuclear power plants within the United States and potentially throughout the world. The INPO Server 112 allows commercial nuclear power plants to submit or post industry specific information regarding the procedure, maintenance, safety, and health of a nuclear power plant. Such posts or submissions are compiled together as OE data 115, which is then made available to others for review. Generally, the OE data 115 includes multiple messages or records submitted by various companies and/or individuals within the industry. One skilled in the art will recognize that the OE data 115 can be formatted in various usable forms such as, but not limited to, plain text or extensible markup language (XML). Table 1 illustrates an example of a record or message within the OE data 115 formatted in XML. Moreover, any attachments within the OE data 115 can be converted to text form using the standard Base64 UUEncoding algorithm, so that the attachment can be embedded in the XML file. As shown in Table 1, the record can include, but is not limited to, a group name, group identification number, forum name, forum identification number, topic identification number, message identification number, date and time of post, name of individual submitting the post, name of plant submitting the post, name of utility submitting the post, work e-mail address of individual submitting the post, work telephone number of individual submitting the post, subject of the post, message, and attachments (if any).

TABLE 1
Message in OE Data (Example)

```
<?xml version=“1.0” encoding=“iso-8859-1”?>
<Articles>
  <Article>
    <GroupName>Emergency Preparedness</GroupName>
    <GroupID>4</GroupID>
    <ForumName>General </ForumName>
    <ForumID>14</ForumID>
    <TopicID>73831</TopicID>
    <MessageID>73831</MessageID>
    <PostedDateTime>1/14/2006 11:08:57 AM</PostedDateTime>
    <PostedByName>Smith, John A.</PostedByName>
    <PostedPlantName>INPO</PostedPlantName>
    <PostedUtilityName />
    <PostedWorkEmail>JSmith@abc.org</PostedWorkEmail>
    <PostedWorkPhone>555/555-5555</PostedWorkPhone>
    <Subject>Recovery Plans</Subject>
    <HTMLMessage>&lt;FONT size=2&gt;&lt;P&gt;The following message is
being posted on the behalf of Jack Jones, Canada:&lt;/P&gt;&lt;P&gt;Every
business is exposed to Risks/ hazards. Managing those risks / hazards
involves 4 phases;&lt;/P&gt;&lt;UL&gt;&lt;LI&gt;“Prevention/mitigation” of
risks /hazards,&lt;/LI&gt;&lt;LI&gt;“Preparedness” for a number of design
basis events/accidents,&lt;/LI&gt;&lt;LI&gt;“Response” to those
events/accidents,&lt;/LI&gt;&lt;LI&gt;“Recovery” from the consequences of
those events/accidents.&lt;/LI&gt;&lt;/UL&gt;&lt;P&gt;Each of the above risk
management phases has a plan and associated implementing procedures which
provide required guidance.&lt;/P&gt;&lt;P&gt;In our business recovery from a
LOCA would focus on bringing the affected nuclear unit(s) back into
production.&lt;/P&gt;&lt;P&gt;I need to develop a Recovery Plan which would
provide the framework for establishing a recovery organization, which defines
roles and responsibilities and which manages the coordination and integration
of recovery activities. &lt;/P&gt;&lt;P&gt;I am looking for examples of a
Recovery Plan but the plans do not have be limited to recovery from nuclear
accidents.&lt;/P&gt;&lt;P&gt;Jack Jones&lt;BR&gt;Section Mgr. Emergency
Plans&lt;BR&gt;(555) 111-1111&amp;nbsp; Ext. # 111&lt;BR&gt;Pager # 222-2222&lt;/
P&gt;&lt;/FONT&gt;</HTMLMessage>
    <TextMessage>
The following message is being posted on the behalf of Jack Jones, Canada:
Every business is exposed to Risks/ hazards. Managing those risks / hazards
involves 4 phases;“Prevention/mitigation” of risks /hazards,“Preparedness”
for a number of design basis events/accidents,“Response” to those
events/accidents,“Recovery” from the consequences of those events/accidents.
Each of the above risk management phases has a plan and associated
implementing procedures which provide required guidance.
In our business recovery from a LOCA would focus on bringing the affected
nuclear unit(s) back into production.
I need to develop a Recovery Plan which would provide the framework for
establishing a recovery organization, which defines roles and
responsibilities and which manages the coordination and integration of
recovery activities.
I am looking for examples of a Recovery Plan but the plans do not have be
limited to recovery from nuclear accidents.
Jack Jones
Section Mgr. Emergency Plans
(555) 111-1111 Ext. # 111
Pager # 222-2222</TextMessage>
    <MIMEAttachments />
  </Article>
</Articles>
```

In a exemplary embodiment of the present invention, the OE extractor server 109 includes a memory storage device 118, a data processing unit 121, a user interface 124, and (optionally) a simple mail transfer protocol (SMTP) 127. While the OE extractor server 109 can comprise all of the aforementioned components, one skilled in the art will recognize that the aforementioned components may reside on separate computer devices within a distributed system.

The memory storage device 118 is capable of storing and retrieving data and is in communication with the data processing unit 121 and the user interface 124, such that the data can be provided to and received from the data processing unit 121 and the user interface 124. The memory storage device 118 can include, but is not limited to, volatile and/or non-volatile memory, or a combination thereof.

The data processing unit 121 is configured with hardware and/or software appropriate to perform tasks and provide capabilities and functionality as described herein. The data processing unit 121 communicates with the memory storage device 118 for data processing and the SMTP 127 (optionally) for data distribution. Initially, the data processing unit 121 parses the OE data 115 received from the INPO server 112, such that each record or message within the OE data 115 is stored in a separate file within the memory storage device 118. The data processing unit 121 further filters the files for relevant records or messages that correspond to user provided search criteria, i.e., keywords, forums, and search logic. Additionally, the data processing unit 121 is capable of distributing the matching results discovered during the filtering process to the corresponding user, such as by e-mail via the SMTP 127. Further, as described in more detail below, the data processing unit 121 generates a summary report indicating which users received particular records or messages parsed from the OE data 115.

The SMTP 127 is adapted to send e-mails generated by the data processing unit 121 to the corresponding users. For example and not limitation, the SMTP 127 provides an e-mail containing results from the data processing unit 121 to the corresponding communication device 106A-106N associated with the registered user (or alternatively to the e-mail server associated with the registered user, so that the user can then view the e-mail utilizing an e-mail application residing on a communication device 106A-106N). One skilled in the art will recognize, however, that results generated by the data processing unit 121 can be provided to registered users via other communication mediums such as, but not limited to, web-based reports, facsimile, voicemail, or printed documents.

The user interface 124 is adapted to receive data from a user (such as through a communication device 106A-106N) and provide the received data to the memory storage device 118 for storage. For example and not limitation, the user can provide desired search criteria, which are associated with the particular user, to be subsequently used by the data processing unit 121. One skilled in the art will recognize that the user interface 124 may be designed in a variety of embodiments and formats and may range from a simple to a more complex configuration. Further, the user interface 124 can be configured so that each registered user of the OE processing system 100 is capable of modifying, adding, and/or deleting search criteria stored on the memory storage device 118, or can be configured so that only a designated administrator (with appropriate security privileges) is capable of modifying, adding, and/or deleting search criteria for a particular user.

One skilled in the art will recognize that elements of the operating experience processing system 100, discussed above, can be connected through any appropriate communication channels that allow for bi-directional communication of signals and/or data. Such communication channels include, but are not limited to, analog, digital, wired and wireless communication channels. The communication channels may be copper wire, optical fiber, radio frequency (RF), infrared, satellite, and the like.

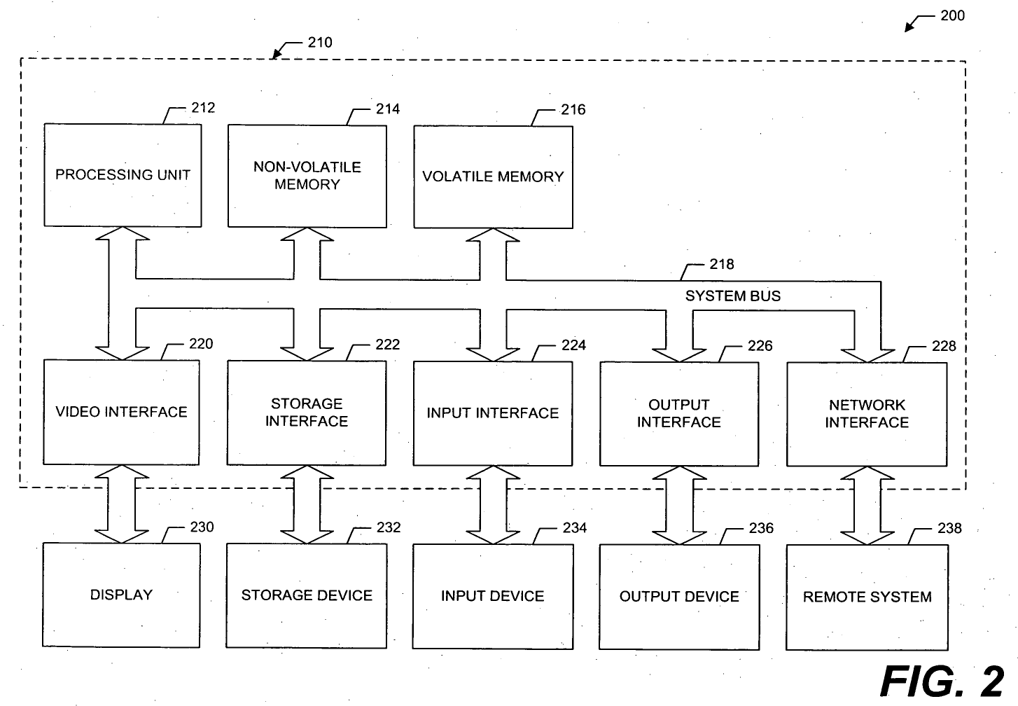

FIG. 2 displays a block diagram representation of a computing environment 200 which may be utilized in accordance with exemplary embodiments of the operating experience processing system 100 of the present invention. More particularly, communication devices 106A-106N, OE extractor server 109, and INPO server 112 can use the computing environment 200 described herein. Communication devices 106A-106N, OE extractor 109, and INPO server 112 of the operating experience processing system 100 can include, but are not limited to, personal computers, mainframe computers, servers, hand-held or laptop devices, multiprocessor systems, microprocessor-based systems, set-top boxes, programmable consumer electronics, network PCs, minicomputers, distributed computing environments that include any of the above systems or devices, and the like. It should be understood, however, that the features and aspects of the operating experience processing system 100 can be implemented by or into a variety of systems and system configurations and any examples provided within this description are for illustrative purposes only.

FIG. 2 and the following discussion provide a general overview of a platform onto which an embodiment of the present invention, or portions thereof, can be integrated, implemented and/or executed. Although reference has been made to instructions within a software program being executed by a processing unit, those skilled in the art will understand that at least some of the functions performed by the software can also be implemented by using hardware components, state machines, or a combination of any of these techniques. In addition, a software program which may implement an embodiment of the present invention can also run as a stand-alone program or as a software module, routine, or function call, operating in conjunction with an operating system, another program, system call, interrupt routine, library routine, or the like. The term program module is used herein to refer to software programs, routines, functions, macros, data, data structures, or any set of machine readable instructions or object code, or software instructions that can be compiled into such, and executed by a processing unit 212.

Turning now to the figure, computing device 210 may comprise various components including, but not limited to, a processing unit 212, a non-volatile memory 214, a volatile memory 216, and a system bus 218. The non-volatile memory 214 can include a variety of memory types including, but not limited to, read only memory (ROM), electronically erasable read only memory (EEROM), electronically erasable and programmable read only memory (EEPROM), electronically programmable read only memory (EPROM), electronically alterable read only memory (EAROM), FLASH memory, bubble memory, battery backed random access memory (RAM), compact disc read only memory (CDROM), digital versatile disc (DVD), or other optical disk storage, magnetic cassettes, magnetic tape, magneto-optical storage devices, magnetic disk storage or other magnetic storage devices, or any other medium which may be used to store the desired information. The non-volatile memory 214 can provide storage for power-on and reset routines (bootstrap routines) that are invoked upon applying power or resetting the computing device 210. In some configurations the non-volatile memory 214 can provide the basic input/output system (BIOS) routines that are utilized to perform the transfer of information between elements within the various components of the computing device 210.

The volatile memory 216 can include a variety of memory types and devices including, but not limited to, random access memory (RAM), dynamic random access memory (DRAM), synchronous dynamic random access memory (SDRAM), double data rate synchronous dynamic random access memory (DDR-SDRAM), bubble memory, registers, or the like. The volatile memory 216 can provide temporary storage for routines, modules, functions, macros, data, etc. that are being or may be executed by, or are being accessed or modified by, the processing unit 212.

Alternatively, the non-volatile memory 214 and/or the volatile memory 216 can be a remote storage facility accessible through a distributed network system. Additionally, the non-volatile memory 214 and/or the volatile memory 216 can be a memory system comprising a multi-stage system of primary and secondary memory devices, as described above. The primary memory device and secondary memory device can operate as a cache for each other or the second memory device can serve as a backup to the primary memory device. In yet another embodiment, the non-volatile memory 214 and/or the volatile memory 216 can comprise a memory device configured as a simple database file or as a searchable, relational database using a query language, such as SQL.

The computing device 210 can access one or more external display devices 230 such as a CRT monitor, LCD panel, LED panel, electro-luminescent panel, or other display device, for the purpose of providing information or computing results to a user. In some embodiments, the external display device 230 can actually be incorporated into the product itself. For example, the computing device 210 can be a mobile device having a display device 230. The processing unit 212 can interface to each display device 230 through a video interface 220 coupled to the processing unit 210 over the system bus 218.

In operation, the computing device 210 sends output information to the display 230 and to one or more output devices 236 such as a speaker, modem, printer, plotter, facsimile machine, RF or infrared transmitter, computer or any other of a variety of devices that may be controlled by the computing device 210. The processing unit 212 can interface to each output device 236 through an output interface 226 coupled to the processing unit 212 over the system bus 218.

The computing device 210 can receive input or commands from one or more input devices 234 such as, but not limited to, a keyboard, pointing device, mouse, modem, RF or infrared receiver, microphone, joystick, track ball, light pen, game pad, scanner, camera, computer or the like. The processing unit 212 may interface to each input device 234 through an input interface 224 coupled to the processing unit 212 over the system bus 218.

It will be appreciated that program modules implementing various embodiments of the present invention can be stored in the non-volatile memory 214, the volatile memory 216, or in a remote memory storage device accessible through the output interface 226 and the input interface 224. The program modules can include an operating system, application programs, other program modules, and program data. The processing unit 212 can access various portions of the program modules in response to the various instructions contained therein, as well as under the direction of events occurring or being received over the input interface 224.

The computing device 210 can provide data to and receive data from one or more other storage devices 232, which can provide volatile or non-volatile memory for storage and which can be accessed by computing device 210. The processing unit 212 can interface to each storage device 232 through a storage interface 222 over the system bus 218.

The interfaces 220, 222, 224, 226, and 228 can include one or more of a variety of interfaces, including but not limited to, cable modems, DSL, T1, T3, optical carrier (e.g., OC-3), V-series modems, an RS-232 serial port interface or other serial port interface, a parallel port interface, a universal serial bus (USB), a general purpose interface bus (GPIB), an optical interface such as infrared or IrDA, an RF or wireless interface such as Bluetooth, and the like.

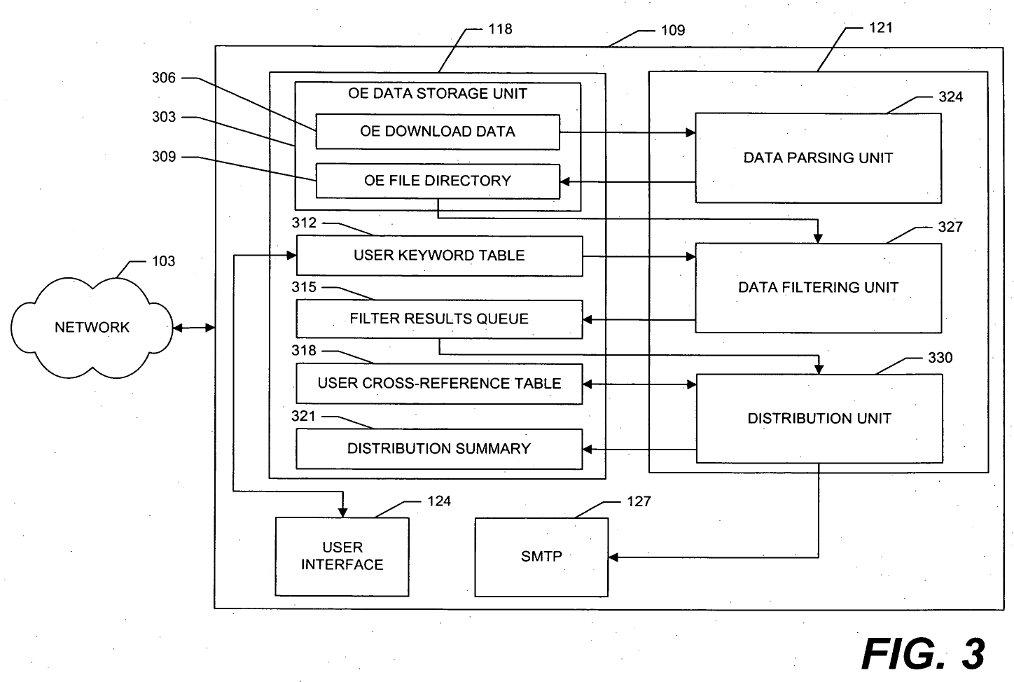

FIG. 3 displays a block diagram representation of an OE extractor server 109 utilized to process received OE data 115 in accordance with exemplary embodiments of the present invention. After receiving the OE data 115 from the INPO server 112, the data processing unit 121 of the OE extractor server 109 parses the OE data 115 and, subsequently, filters the parsed OE data 115 for messages or records that match predetermined search criteria provided by a registered user. The data processing unit 121 then distributes the results from filtering the parsed OE data 115 to the corresponding users. Further, the data processing unit 121 summarizes which records or messages of the OE data 115 were sent to specific registered users.

To facilitate the processing of OE data 115, the data processing unit 121 can comprise a data parsing unit 324, data filtering unit 327, and a distribution unit 330. Further, the memory storage device 118 can include an OE data storage unit 303, user keyword table 312, filter results queue 315, user cross-reference table 318, and distribution summary 321. The OE data storage unit 330 is adapted to store the OE data 115 received from the INPO server 112, as well as the parsed OE data 115 generated by the data processing unit 121. Accordingly, the OE data storage unit 330 can also include OE download data 306 (e.g., the OE data 115 once received from the INPO server 112) and an OE file directory 309.

The data parsing unit 324 is configured with hardware and/or software appropriate to perform tasks and provide capabilities and functionality as described herein. More particularly, the data parsing unit 324 is adapted to receive the OE download data 306 from the OE data storage unit 303 for parsing. The data parsing unit 324 generates an individual message file for each message or record within the OE download data 306. Further, the data parsing unit 324 generates an individual attachment file for each attachment within the OE download data 306. If an attachment is processed, the data parsing unit 324 adds a link to the generated attachment file into the corresponding message file (which has already been generated). If, however, the attachment is an image or in another acceptable format, the attachment can be embedded within the message file, instead of creating a link to the attachment file. The data parsing unit 324 assigns each message and attachment file with a unique filename and then provides the file to the OE file directory 309 for storage. Generally, the message file contains text based information, while the attachment file can include, but is not limited to, text, photographs, drawings, audio, or video.

For the message file, the data parsing unit 324, for example, can assign the file name comprising the last two digits of the year, followed by the two digit representation of the month, followed by the two digit representation of the day (YYMMDD), followed by a dash (-), and finally followed by the relevant message identification number. For the attachment file, the data parsing unit 324, for example, can assign the file name comprising the message file name (as described above) followed by the actual name of the attachment. Accordingly, all attachment files can be easily associated with the original message files. The message file and attachment file can also be followed by the appropriate file extension. In a exemplary embodiment of the present invention, the data parsing unit 324 generates each message file into a hypertext markup language (HTML) document, including hyperlinks to any relevant attachment files.

The data parsing unit 324 can also generate a master file that contains a link to a message file, message subject, and a message summary, for every message file generated from the OE data 115. The master file is generally used by an administrator to evaluate what message and attachment files have been generated by the data parsing unit 324.

The data filtering unit 327 is configured with hardware and/or software appropriate to perform tasks and provide capabilities and functionality as described herein. More particularly, the data filtering unit 327 is adapted to filter the message and attachment files stored in the OE file directory 309 for relevant files matching the predetermined search criteria provided by a particular user and stored in the user keyword table 312. The data filtering unit 327 then generates separate filter results for each user identified in the user keyword table 312 (if a match has been found in the message and attachment files). The data filtering unit 327 can be applied to only those message and attachment files identified within a certain date range, such that the data filtering unit 327 can provide filter results on all available message and attachment files, those of which are within a certain date range, or all of those associated with a particular day.

The user keyword table 312 is in communication with the user interface 124, thereby allowing a user or designated administrator to add, modify, or delete search criteria associated with a particular user. Such designation of search criteria for a particular user generally occurs prior to the filtering process of the data filtering unit 327. As described above, the user interface 124 permits a user or administrator to easily and efficiently make changes to the search criteria for a particular user and, therefore, effectively alter the filtering process conducted by the data filtering unit 327 for the particular user. Generally, the user is identified with the search criteria by an e-mail address or username. For example, and not limitation, Table 2 illustrates a list of search criteria associated with particular users. In addition to the search criteria, the user can also specify particular filtering (or search) logic to be used by the data filtering unit 327 during the filtering process. One skilled in the art will recognize that filtering and searching logic can utilize certain operators (such as Boolean logic) special characters, and wildcards to produce more relevant results. Additionally, one skilled in the art will recognize that search criteria could be associated with users through separate user search criteria tables, such as a user keyword table 312 and a user forum table (not shown). In such a case, the data filtering unit 327 would perform the filtering process for each of the user search criteria tables.

TABLE 2
Search Criteria (Example)

| | |
|---|---|
| Search Type | Search Criteria |

User Name: Jay Dillon
E-mail: jdillon@abc.org

| | |
|---|---|
| EXACT MATCH | ARV |
| LIKE | AUXILIARY FEED WATER |
| LIKE | BLOWER |
| LIKE | CIRC+ WATER |
| LIKE | COMPRESSOR |
| LIKE | DIESEL |
| LIKE | DIESEL GENERATOR |
| LIKE | DRYER |
| LIKE | HYDRAULIC |
| LIKE | INPO.PLANTEVENTREPORTS.OPERATINGEXPERIENCEREPORTS |
| LIKE | INPO.PLANTEVENTREPORTS.OPERATIONSANDMAINTENANCEREMINDERS |
| LIKE | INPO.PLANTEVENTREPORTS.SEN |
| LIKE | INPO.PLANTEVENTREPORTS.SER |

User Name: Susan Jones
E-mail: sjones@abc.org

| | |
|---|---|
| EXACT MATCH | AFW |
| LIKE | AIR OPERATED VALVES |
| EXACT MATCH | AOV |
| EXACT MATCH | ARV |
| LIKE | ASBESTOS |
| EXACT MATCH | ASME |
| LIKE | AUXILIARY FEED WATER |
| LIKE | CHARGING PUMP |
| LIKE | CHECK VALVES |
| LIKE | COMPRESSOR |
| LIKE | DIESEL |
| LIKE | DIESEL GENERATOR |
| EXACT MATCH | EHC |
| LIKE | ELECTRO HYDRAULIC |
| LIKE | ELECTROHYDRAULIC |
| LIKE | FEED PUMP |
| EXACT MATCH | FSAR |
| EXACT MATCH | MOV |
| EXACT MATCH | MOVS |

User Name: Ron Wilson
E-mail: rwilson@abc.org

| | |
|---|---|
| LIKE | ENVIRONMENTAL PROTECTION PLAN |
| LIKE | HAZARDOUS MATERIALS AND TRANSPORTATION |
| LIKE | HAZARDOUS WASTE OR REFUSE |
| LIKE | HEALTH PHYSICS |
| LIKE | HEAT |
| EXACT MATCH | HEPA |
| LIKE | INPO.PLANTEVENTREPORTS.OPERATINGEXPERIENCEREPORTS |
| LIKE | LANDFILL |
| LIKE | LEAKAGE |
| LIKE | RAD WASTE |
| LIKE | RADIATION |
| LIKE | RADIOACTIVE WASTE |
| LIKE | RADWASTE |
| EXACT MATCH | TLD |
| LIKE | WASTE |
| LIKE | WASTE MINIMIZATION |
| LIKE | WASTE OIL |
| LIKE | WNN.RADIATIONPROTECTION.DOSIMETRY |
| LIKE | WNN.RADIATIONPROTECTION.GENERAL |
| LIKE | WNN.RADIATIONPROTECTION.INSTRUMENTAT |

Generally, the data filtering unit 327 begins by receiving a first user's search criteria. IN an exemplary embodiment, the search criteria may include a predetermined list of keywords and/or forums as well as search logic. The data filtering unit 327 then begins to filter all of the message and attachment files from the OE file directory 309 for possible matches. If a match is found, the data filtering unit 327 generates filter results for the particular user. The data filtering unit 327 does not halt the filtering process when one keyword is found, but checks all provided search criteria to determine if other matches exist for the particular message file.

The filter results, for example, can include a link to the message file, the subject line of the message, the search criteria that triggered the match, and a summary of the message within the message file. The data filtering unit 327 continues to add to the filter results for the particular user until all of the messages and attachment files (corresponding to the corresponding date range) have been filtered. The data filtering unit 327 then receives the new list of keywords and user for a second user and repeats the process. New filter results are generated by the data filtering unit 327 for each user having associated search criteria, where a message or attachment file has been found to match with the search criteria. If none of the search criteria for the user result in a corresponding message or attachment file, then the data filtering unit 327 does not generate filter results for the user.

In a exemplary embodiment of the present invention, the filters results comprise an individual e-mail message to the corresponding user associated with the search criteria that were used to generate the filter results. As described above, a separate e-mail would be created by the data filtering unit 327 for each user that has provided search criteria that resulted in a match during the filtering process of the message and attachment files. The e-mail containing the search results is provided by the data filtering unit 327 to the filter results queue 315 for storage. Table 3 illustrates an example e-mail generated by the data filtering unit 327 for a user having predetermined search criteria. As the filter results contain merely a link to the message file, the subject line of the message, the search criteria that triggered the match, and a summary of the message, the user receiving the filter results can easily process the information and determine if the filtered OE data 115 is relevant. Once a user clicked on a provided link, the user would be able to access the full message file from the OE file directory 309 and also see any attachment files associated with the message file.

TABLE 3
Filter Results E-mail (Example)

| | |
|---|---|
| From: | OE Extractor Server <admin@abc.org> |
| To: | Susan Jones <sjones@abc.org> |
| Subject: | OE Results for Search criteria (Daily Edition) |
| Subject: | OE21399 - Susquehanna 1 - Primary Containment Instrument Lines |

Located Outside Secondary Containment.
Newsgroups: Operating Experience Daily Data Entry, Operations
Abstract: Six Primary Containment instrument lines penetrated the Unit 1 Reactor Building's Railroad
Bay. Although the area can be aligned to Secondary Containment, it has not normally been maintained in this
configuration. The instrument lines that are located in the Railroad Bay, and have been typically
located outside Secondary Containment due to ventilation system alignment practices, are not
consistent with assumptions currently found in station licensing documents. Susquehanna Operations eliminated the
non-conforming condition by reconfiguring Secondary Containment in a manner that encompassed the Railroad Bay.
On four occasions Operations temporarily returned the Railroad Bay to its normal configuration (e.g., ventilation
outside of secondary containment) to support plant maintenance activities. A misinterpretation of GL 91-18 guidance and Susquehanna's belief that the
Secondary Containment function was not affected by returning the plant to its normal and customary ventilation alignment caused Operators to
complete the reconfiguration without entering the Secondary Containment LCO. Administrative controls have since been enacted to ensure the
Railroad Bay is aligned to Secondary Containment when the Railroad Bay door is not open. The appropriate Tech Spec LCO is being
entered when the door must be opened. A modification is planned that will place the instrument lines inside Secondary Containment
at all times. There were no adverse consequences to the health and safety of the public as a result of this situation.
Subject: OE21400 - Mobile Crane Contacted an Overhead 13.8 KV Power Line
Keyword: STEAM GENERATOR
Abstract: Workers were staging equipment needed for activities at the temporary steam generator storage facility. A crew consisting of a crane
operator and two spotters were using a deck crane to lift and transport equipment. A piece of equipment was removed from its storage box and placed
on the deck of the crane for transport to the temporary building. During transport, the crane boom came into contact with the neutral/ground wire on
an energized 13.8 KV power line. The neutral/ground wire was damaged, no arcing was reported and no personnel injuries occurred.
Subject: OE21401 - Cooling Fan Failure On Standby Service Water Tower Fan
Motor
Newsgroups: Operating Experience Daily Data Entry
Abstract: During a start up of Standby Service Water ‘B’ system, an unusual noise was heard coming from the ‘C’ tower fan motor. Subsequence
inspection found that the cooling fan had separated and was no longer providing cooling to the tower fan motor. Aging of the fan's polypropylene
material and thermal cycling caused the failure of the fan

The distribution unit 330 is configured with hardware and/or software appropriate to perform tasks and provide capabilities and functionality as described herein. More particularly, the distribution unit 330 is adapted to distribute the filter results from the filter results queue 315 to each user having corresponding filter results based on the predetermined search criteria. Further, the distribution unit 330 is adapted to generate a user cross-reference table 318 that lists each message file (by message identification number, for example) and the users to which the distribution unit 330 provided a link and summary of the content of the particular message. The distribution unit 330 can utilize the user cross-reference table 318 to generate a distribution summary 321 which can be subsequently used by an administrator. The distribution summary 321 generally comprises the message subject line for each corresponding message file that had been filtered by the data filtering unit 327 and a list of users who received filter results containing a link to that message by the distribution unit 330.

In a exemplary embodiment of the present invention, the distribution unit 330 receives the generated filter results from the filter results queue 315. The filter results for each user are generally represented in an individual e-mail addressed to the corresponding user. The distribution unit 330, therefore, utilizes the SMTP 127 to distribute each of the e-mails to the users. Accordingly, the distribution unit 330 effectively distributes filter results generated by the data filtering unit 327 to each user having a keyword or forum identified in the message and attachment files (for a designated date range) created by the data parsing unit 324. Generally, only one e-mail containing the filter results is provided to each user during the distribution process.

In operation, the OE data 115 is received from the INPO server 112 by the OE extractor server 109 and stored in the OE data storage unit 303 as OE download data 306. Generally, the OE extractor server 109 receives OE data 115 on a predetermined, regular basis (e.g., every twenty-four hours). Once activated (either manually or automatically), the data parsing unit 324 of the data processing unit 121 parses the OE download data 306, which generally contains multiple messages or records and attachments, into individual message files and attachment files. The individual message files are typically formatted as HTML documents and utilize a unique file naming scheme. The attachment files are generally converted from an encoded text format into a binary format. The generated message files and attachment files are stored in the OE file directory 309. The OE file directory 309, for example, is generally accessible to users of the operating experience processing system 100 via an intranet or securely via the Internet.

In another embodiment of the present invention, the generated message files and attachment files can be stored in the OE file directory 309 residing in a shared file space (such as a file server or network drive), wherein individuals receiving links to the message files and attachment files can retrieve the files without using a web browser or the hyper text transfer protocol (HTTP). Accordingly, the present invention can be implemented without utilizing a client/server architecture.

At a predetermined time (either manually or automatically), the data filtering unit 327 of the data processing unit 121 filters all of the message files and attachment files in the OE file directory 309, based on a particular set of criteria (e.g., all message and attachment files from a particular date range). The data filtering unit 327 filters the relevant message files and attachment files using predetermined search criteria for a particular user. The data filtering unit 327 receives the search criteria for a particular user form the user keyword table 312. Generally, the data filtering unit 327 repeats the process of filtering all of the relevant message files and attachment files for each user that has provided search criteria.

The data filtering unit 327 generates filter results for each appropriate user where matches occurred during the filtering process and provides the filter results to the filter results queue 315 for storage. The filter results can be in the form of an e-mail message addressed to the corresponding user that provided the search criteria used during the filtering process.

The distribution unit 330 of the data processing unit 121 receives the filter results for each user from the filter results queue 315 and distributes the filter results to the appropriate users. For example, the distribution unit 330 can utilize the SMTP 127 to send the generated e-mails to the users. Further, the distribution unit 330 generates a user cross-reference table 318 to be used to create a distribution summary 321, which is stored on the memory storage device 118. The distribution summary 321, as described above, summarizes each of the message files within the OE file directory 309 and lists each user to which the particular message file has been provided. An administrator can then use the distribution summary 321 to determine which message files a particular user had been sent if, for example, the user has deleted the filter results (e.g., e-mail) distributed by the distribution unit 330.

Once a user receives the filter results, the user can link to the actual message files within the OE file directory 309. Further, if the message files include a link to a corresponding attachment file, the user can also view the attachment file by following the appropriate link. As the filter results are designed for increased readability and ease of use, users can receive relevant and useful information from the OE data 115, which can then be used to improve safety, health, and maintenance of a commercial nuclear power plant.

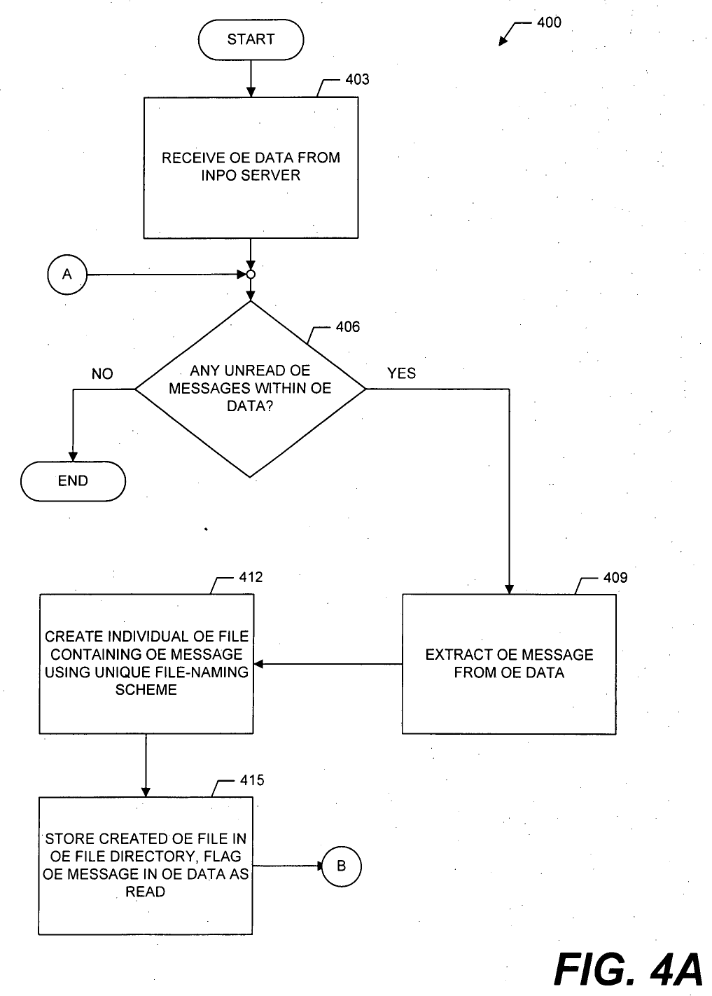

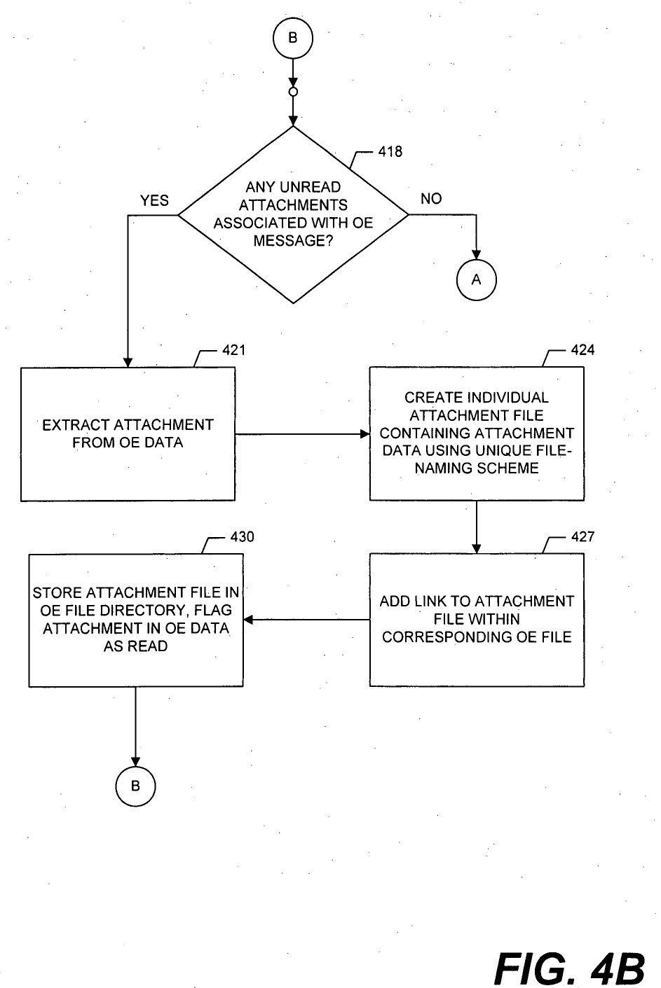

FIGS. 4A-4B, collectively known as FIG. 4, display a logic flow diagram representing a method 400 of parsing received OE data 115 in accordance with exemplary embodiments of the present invention. After the INPO server 112 provides the OE extractor server 109 with the OE data 115, the received OE data 115 is stored on the memory storage device 118 as OE download data 306. Upon activation of the data processing unit 121, the OE download data 306 is parsed into separate message and attachment files as defined within the original OE data 115. The individual message and attachment files are provided unique file names, using a naming scheme that utilizes, for example, the date in which the OE data 115 was received by the OE extractor server 109. Finally, the individual message and attachment files are stored in the OE file directory 309 of the memory storage device 118 for later access by users.

More specifically, the method 400 of parsing received OE data 115 begins at 403 where the OE data 115 is received from the INPO server 112 by the OE extractor server 109. The OE data 115 is then stored on the memory storage device 118 as OE download data 306. When the parsing process is initiated, the data parsing unit 324 of the data processing unit 121 receives the OE download data 306 from the memory storage device 118 and, at 406, determines whether any unread OE messages exist within the OE download data 306. Unread OE messages are those messages that have not yet been considered or parsed by the data processing unit 324. After the data processing unit 324 considers an OE message, it can be marked as “READ” within the OE download data 306 or the data processing unit 324 may move on to the next OE message within the OE download data 306, thereby causing a pointer to move beyond the previously considered OE message. Accordingly, each OE message within the OE download data 306 is only considered once during the parsing process.

If, at 406, the data parsing unit 324 determines that there are no unread OE messages within the OE download data 306 left to be considered, then the “NO” branch is followed and the data parsing unit 324 terminates operation in accordance with method 400. If, however, at 406 the data parsing unit 324 determines that there are unread OE messages within the OE download data 306, then the “YES” branch is followed to 409 where the data parsing unit 324 extracts the individual OE message from the OE download data 306. Next, at 412, the data parsing unit 324 creates an individual message file containing the OE message. The data parsing unit 324 provides the message file with a unique filename by using a predetermined file-naming scheme (e.g., using the date that the OE data 115 was received as part of the filename).

At 415, the data parsing unit 324 provides the newly named message file to memory storage unit 118 for storing in the OE file directory 309. If necessary, the data parsing unit 324 then marks the OE message within the OE download data 306 as “READ”. At 418, the data parsing unit 324 determines whether any unread attachments within the OE download data 306 are associated with the recently extracted OE message. If, at 418, the data parsing unit 324 determines that there are no unread attachments associated with the extracted OE message, then the data parsing unit 324 proceeds to 406, described above.

If, however, at 418 the data parsing unit 324 determines that there are unread attachments associated with the extracted OE message, then the data parsing unit 324 proceeds to 421 where the data parsing unit 324 extracts the attachment from the OE download data 306. Then, at 424, the data parsing unit 324 creates an individual attachment file containing the attachment data extracted from the OE download data 306. The data parsing unit 324 provides the attachment file with a unique filename generated by using a predetermined file-naming scheme (so that the attachments are related to the corresponding message file).

Next, at 427, the data parsing unit 324 modifies the corresponding message file to include a link, such as a hyperlink, to the attachment file. The data parsing unit 324, at 430, provides the newly named attachment file to the memory storage unit 118 to be stored in the OE file directory 309. If necessary, the data parsing unit 324 marks the attachment information in the OE download data 306 as “READ”. The data parsing unit 324 then proceeds to 418, as described above.

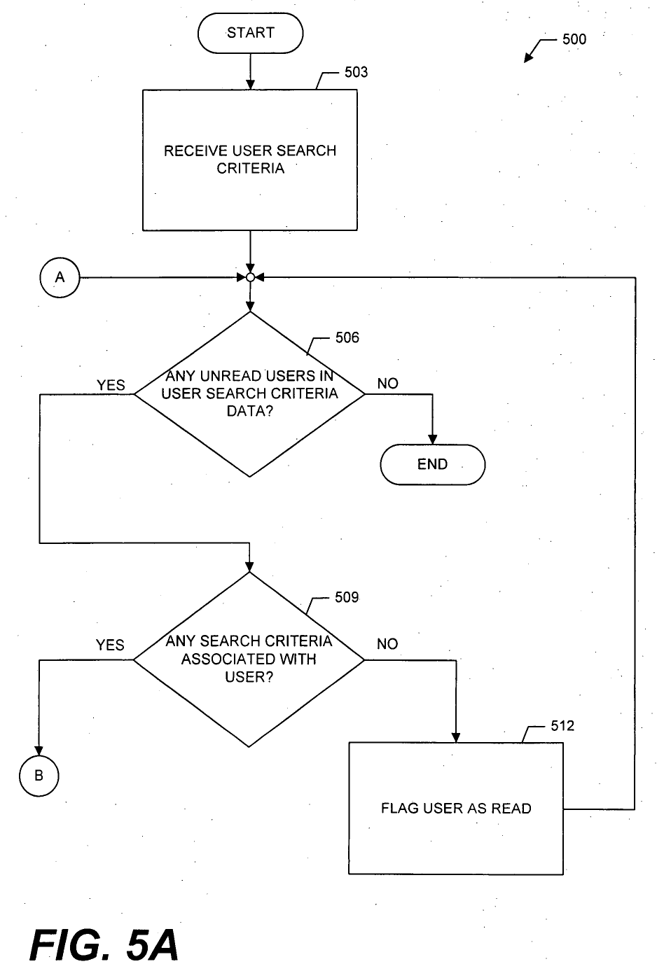

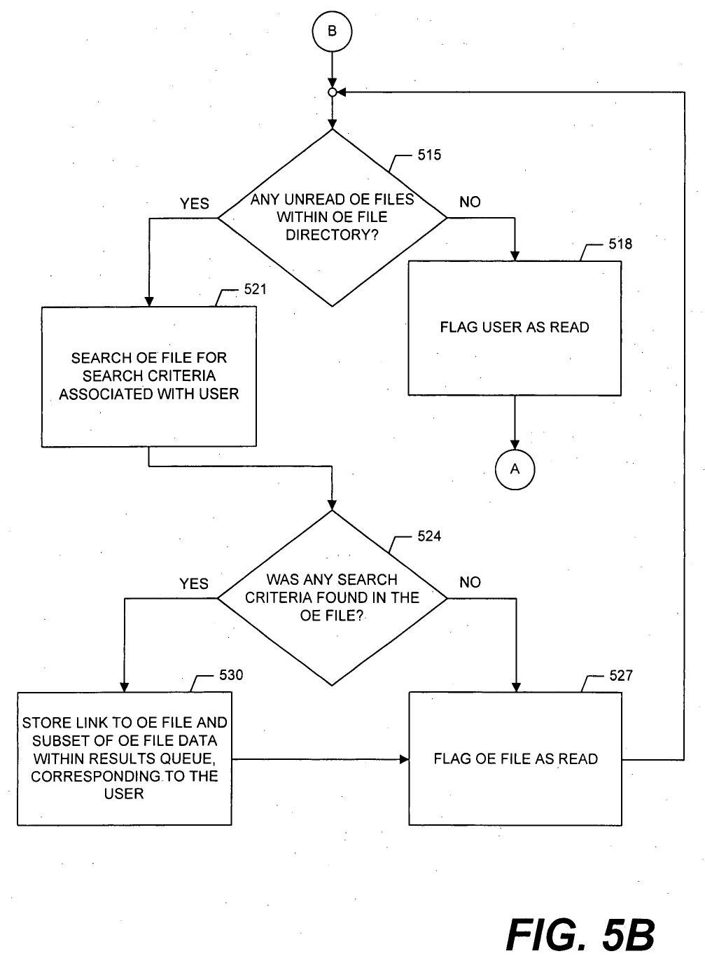

FIGS. 5A-5B, collectively known as FIG. 5, display a logic flow diagram representing a method 500 of filtering operating experience files based on predetermined user keywords in accordance with exemplary embodiments of the present invention. After the received OE data 115 has been parsed and separated into individual message and attachment files (which are stored in the OE file directory 309), the filtering process can be initiated by the data filtering unit 327 of the data processing unit 121. The data filtering unit 327 receives a list of predetermined search criteria for a particular user from the user keyword table 312 of the memory storage unit 118. The data filtering unit 327 uses the provided search criteria to filter each of the message files and/or attachment files within the OE file directory 309. As the predetermined naming scheme of the message files and attachment files is associated with the date the OE data 115 was received, the data filtering unit 327 can filter message and attachment files for various date ranges. In a exemplary embodiment, the data filtering unit 327 filters message and attachment files from a particular day. In other words, the data filtering unit 327 filters the messages and attachments associated with the OE data 115 received on a particular day. The data filtering unit 327, however, can be used to filter message and attachment files associated with multiple days. If the data filtering unit 327 determines that a message or attachment file matches a keyword or forum for a particular user, then the data filtering unit 327 generates filter results, such as an e-mail, that contains a predetermined subset of data from the message file (e.g., a link to the message file, a summary of the message, and a brief description of the message). The filter results are provided by the data filtering unit 327 to the filter results queue 315 of the memory storage unit 118 for storage.

More specifically, the method 500 of filtering operating experience files based on predetermined user keywords beings at 503 where the data filtering unit 327 receives predetermined search criteria for all registered users from the user keyword table 312. Next, at 506, the data filtering unit 327 determines whether there are any unread users within the received search criteria (as the search criteria are generally indexed by the user within the user keyword table 312). If, at 506, the data filtering unit 327 determines that there are no unread users in the received user search criteria data, then the “NO” branch is followed and the data filtering unit 327 terminates operation in accordance with method 500.

If, however, at 506 the data filtering unit 327 determines that there are unread users in the user search criteria data, then the “YES” branch is followed to 509 where the data filtering unit 327 determines whether there are any search criteria associated with the particular user. If, at 509, the data filtering unit 327 determines that there are no search criteria associated with the particular user, then the data filtering unit 327 follows the “NO” branch to 512 where the user is marked as “READ”. The data filtering unit 327 then proceeds to 506, described above.

If, however, at 509 the data filtering unit 327 determines that there are search criteria associated with the particular user, then the data filtering unit 327 follows the “YES” branch to 515, where the data filtering unit 327 determines if there are any unread message or attachment files in the OE file directory 309. If, at 515, the data filtering unit determines that there are no unread message and attachment files in the OE file directory 309, then the data filtering unit 327 follows the “NO” branch to 518, where the data filtering unit 327 marks the user as “READ”. The data filtering unit 327 then proceeds to 506, described above.

If, however, at 515 the data filtering unit 327 determines that there are unread message and attachment files within the OE file directory 309, then data filtering unit 327 follows the “YES” branch to 521 where the data filtering unit 327 searches the message or attachment file for predetermined search criteria provided by the particular user. At 524, the data filtering unit 327 determines whether the message or attachment file contains search criteria provided by the user. If, at 524, the data filtering unit 327 determines that that the message file or attachment file does not contain search criteria provided by the user, then the “NO” branch is followed to 527, where the data filtering unit 327 marks the message or attachment file as “READ” and then proceeds to 515, described above.

If, however, at 524 the data filtering unit 327 determines that the message or attachment file does contain search criteria provided by the user, then the “YES” branch is followed to 530 where the data filtering unit 327 stores a link to the message or attachment file, the subject of the message, and an abstract or summary of the message as filter results within the filter results queue 315 of the memory storage unit 118. The link, subject, and abstract stored by the data filtering unit 327 are stored as filter results associated with the particular user. Additional information can be subsequently appended to the filter results for the particular user by the data filtering unit 330. Generally, there exists only one set of filter results for each user identified within the user keyword table 312. The data filtering unit 327 then proceeds to 527, described above.

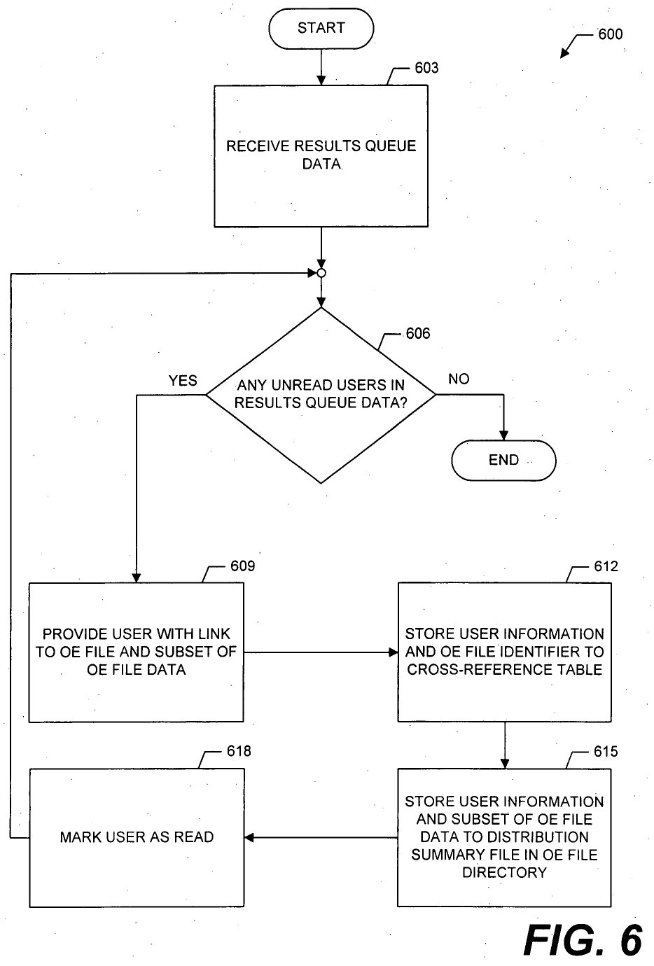

FIG. 6 displays a logic flow diagram representing a method 600 of distributing filtered results to users in accordance with exemplary embodiments of the present invention. After the data filtering unit 327 has generated a set of filter results for various registered users, the distribution unit 330 of the data processing unit 121 can provide each set of filter results to the corresponding user for review. For example, the distribution unit 330 can received the filter results from the filter results queue 315 and send the corresponding user an e-mail containing the filter results via the SMTP 127. Further, the distribution unit 330 can generate a user cross-reference table 318 to be used to create a distribution summary 321 that lists the message subject for each of the message files identified as containing search criteria associated with the particular user during the filtering process. Each message subject within the distribution summary 321 is followed by a list of users that received filter results that contained the message subject (and other information). An administrator can, therefore, determine which message subjects a particular user was provided, without having to rerun the filtering process.

More particularly, the method 600 of distributing filtered results to users begins at 603 where the distribution unit 330 receives all of the filter results from the filter results queue 315. At 606, the distribution unit 330 determines whether there are any unread users within the filtered results. If, at 606, the distribution unit 330 determines that there are no unread users within the filter results, then the “NO” branch is followed where the distribution unit 330 terminates operation in accordance with method 600.

If, however, at 606 the distribution unit 330 determines there are unread users in the filter results, then the distribution unit 330 follows the “YES” branch to 609 where the distribution unit 330 provides the set of filter results associated with a particular user to said user. For example, the distribution unit 330 can e-mail the set of filter results to the user via the SMTP 127. Next, at 612, the distribution unit 330 stores the user identification information (e.g., the username or e-mail address of the user) and the message subject and/or link for each OE message referenced in the set of filter results into a user cross-reference table 318.

At 615, the distribution unit 330 stores the user identification information and message subject and/or link for each OE message referenced in the set of filter results to a distribution summary 321. The distribution unit 330 can utilize the user cross-reference table 318 to create the distribution summary 321 after all sets of filter results have been provided to the appropriate users. While the user cross-reference table 318 associates each provided message with a particular user, the distribution summary 321 associates each user with a provided message. Then, at 618, the distribution unit marks the user as “READ” and proceeds to 606, described above.

Whereas the present invention has been described in detail it is understood that variations and modifications can be effected within the spirit and scope of the invention, as described herein before and as defined in the appended claims. The corresponding structures, materials, acts, and equivalents of all mean-plus-function elements, if any, in the claims below are intended to include any structure, material, or acts for performing the functions in combination with other claimed elements as specifically claimed.

What is claimed is:

1. A method for processing operating experience data comprising:
receiving one or more search criteria from a user;
receiving operating experience data from one or more INPO server;
parsing the operating experience data into one or more messages;
filtering the one or more messages for the one or more search criteria; and
distributing the messages that are relevant to the search criteria to the user.

2. The method of claim 1, wherein the search criteria includes a keyword that corresponds to a particular type of operating information that is relevant to the user.

3. The method of claim 1, wherein the search criteria includes a forum that corresponds to an interest of a user.

4. The method of claim 1, further comprising generating a distribution summary that includes which messages were distributed to each user.

5. The method of claim 1, wherein the messages are distributed to the user via e-mail.

6. The method of claim 1, wherein the at least a portion of the one or more messages includes an attachment.

7. A system for processing operating experience data comprising:
a user interface that allows a user to provide one or more search criteria;
a memory storage device that stores operating experience data received from a plurality of INPO servers; and
a data processing unit for processing operating experience data comprising:
a data parsing unit that parses the received operating experience data into individual messages and attachment files;
a data filtering unit that uses the provided search criteria to filter the individual messages and attachment files in order to find matches and create a set of filtered results; and
a distribution unit that distributes the set of filtered results to each corresponding user.

8. The system of claim 7, wherein the search criteria includes one or more keywords that correspond to particular types of operating experience data relevant to the user.

9. The system of claim 7, wherein the search criteria includes a forum that corresponds to an interest of a user.

10. The system of claim 7, the search criteria includes a search logic.

11. The system of claim 7, wherein the data parsing unit assigns each message and attachment file a unique filename.

12. The system of claim 7, wherein the distribution unit generates a distribution summary that includes which message and attachment files distributed to each user.

13. The system of claim 7, wherein the data filtering unit filters the individual messages and attachment files from a specific data range to find matches and create the set of filtered results.

14. The system of claim 7, wherein the search criteria provided by the user is stored in a user search criteria table.

15. A computer program product for processing operating experience data, the computer program product comprising: a storage medium readable by a processing circuit and storing instructions for execution by the processing circuit for performing a method comprising:
receiving one or more search criteria from a user;
receiving operating experience data from one or more INPO server;
parsing the operating experience data into one or more messages and attachments;
filtering the one or more messages and attachments for the one or more search criteria; and
distributing the messages that are relevant to the search criteria to the user.

16. The computer program product of claim 15, wherein the search criteria includes one or more keywords that correspond to particular types of operating experience data relevant to the user.

17. The computer program product of claim 15, wherein the search criteria includes a forum that corresponds an interest of a user.

18. The computer program product of claim 15, the search criteria includes a search logic.

19. The computer program product of claim 15, wherein the data parsing unit assigns each message and attachment file a unique filename.

20. The computer program product of claim 15, wherein the distribution unit generates a distribution summary that includes which message and attachment files distributed to each user.
